(19) United States
(12) Patent Application Publication
(10) Pub. No.: US 2021/0179897 A1
(43) Pub. Date: Jun. 17, 2021

(54) Flexible screen protective film

(71) Applicant: Dong-Ya Zhang, Wugang City (CN)

(72) Inventor: Dong-Ya Zhang, Wugang City (CN)

(21) Appl. No.: 16/807,219

(22) Filed: Mar. 3, 2020

(30) Foreign Application Priority Data
Dec. 13, 2019 (CN) 201922235837.5

(51) Int. Cl. C09J 7/40

(52) U.S. Cl. CPC C09J 7/405

(57) ABSTRACT

The utility model provides a flexible screen protective film, which comprises a flexible application layer, a release film, a surface protective film and a positioning sticker. The upper end face of the flexible application layer is divided into a first gluing area and a second gluing area which forms the upper end face together with the first gluing area; the release film is glued to the lower end surface of the flexible application layer; the surface protective film is glued to the first gluing area on the upper end face of the flexible application layer; the positioning sticker is glued with the second gluing area of the upper end face of the flexible application layer, one end of the positioning sticker is connected with the surface protective film, and the other end protrudes from the outer edge of the flexible application layer as the free end. The flexible screen protective film provided by the utility model has the advantages of convenient separation of the release film and the application layer, and high fitting quality of the flexible film and the screen.

### TECHNICAL FIELD

The utility model belongs to the technical field of screen pasting film, and more specifically relates to a flexible screen protective film.

### BACKGROUND OF THE INVENTION

Nowadays, with the development of science and technology, mobile phones, tablet computers and other devices have become essential communication devices in people's daily life, which have both business and reading functions. Most of these devices use touch-screen design, and people will often damage the touch-screen due to many unexpected situations, or be invaded by oil and dust. At the same time, in order to reduce the user's eye fatigue, most people will put a screen protective film on the screen. The screen protective film includes a flexible protective film. The existing flexible film (refer to FIG. 1 and FIG. 2) is mostly composed of application layer, release film adhered with application layer and surface protective film, etc. It is inconvenient to separate the release film from the application layer. In order to facilitate the separation of the release film from the application layer, a cut mark is often made in the middle of the release film. During adhering, the release film is separated from the middle position to both sides, so that when the flexible film adheres with the screen, there will be traces or blisters in the corresponding position of the cut mark of the release film, which will affect the adhering effect of the flexible film and the screen.

Content of Utility Model

The purpose of the utility model is to provide a flexible screen protective film, which aims to solve the technical problems of inconvenient separation between the release film and the application layer in the existing flexible film and poor adhering effect between the flexible film and the screen.

To achieve the above purpose, the technical scheme adopted by the utility model is to provide a flexible screen protective film, which comprises:

The upper end face of the flexible application layer is divided into a first gluing area and a second gluing area which forms the upper end face together with the first gluing area;

The release film is glued to the lower end surface of the flexible application layer;

The surface protective film is glued to the first gluing area on the upper end face of the flexible application layer; and

The positioning sticker is glued with the second gluing area of the upper end face of the flexible application layer, one end of the positioning sticker is connected with the surface protective film, and the other end protrudes from the outer edge of the flexible application layer as the free end.

As another embodiment of the application, one end of the positioning sticker is connected with the surface protective film.

As another embodiment of the application, the lower end face of one end of the positioning sticker is connected with the upper end face of the surface protective film.

As another embodiment of the application, the free end of the positioning sticker is provided with a connection interval for detachable connection with the positioner or the equipment surface, the connecting interval comprises a double-sided adhesive structure.

As another embodiment of the application, the adhesive force between the release film and the flexible application layer is less than that between the positioning sticker and the flexible application layer.

As another embodiment of the application, the first gluing area and the second gluing area are successively arranged along the length direction of the flexible application layer, and the length of the first gluing area is larger than the length of the second gluing area.

As another embodiment of the application, the release film is fixedly connected with a first convex lug protruding from the outer edge of the flexible application layer.

As another embodiment of the application, protective film is fixedly connected with a second convex lug protruding from the outer edge of the flexible application layer.

The utility model provides a flexible screen protective film with the beneficial affect that: compared with the prior art, the utility model provides a flexible screen protective film, which can separate the release film and the flexible application layer with the help of a positioning sticker. When the flexible screen protective film is adhered, the release film does not need to be cut, and the release film does not need to be separated from the middle of the release film to both sides in the order of separation. The film applicator can tear the release film from any direction, which facilitates the separation of the release film and the flexible application layer. There is no cut mark on the release film, and the flexible protective film will not produce traces or blisters when it is attached to the screen, which improves the adhering effect of the flexible film and the screen. The surface protective film avoids the deformation of the flexible application layer in the process of repeatedly pressing the surface protective film by the scraper. The positioning sticker has the positioning function, which facilitates the fitting of the flexible screen protective film and the screen.

### DESCRIPTION OF FIGURES

In order to explain the technical scheme in the embodiment of the utility model more clearly, the following will give a brief introduction to the embodiments or the figures needed in the prior technical description. Obviously, the figures in the following description are only some embodiments of the utility model. For those of ordinary skill in the art, other figures can be obtained according to those figures without any creative work.

FIG. 1 is the side view structure diagram of the flexible screen protective film commonly used in the prior art.

FIG. 2 is the top view structure diagram in FIG. 1;

FIG. 3 is a main view structure diagram of a flexible screen protective film provided by the embodiment of the utility model;

FIG. 4 is the top view structure diagram in FIG. 3;

FIG. 5 is the top view structure diagram after removing the surface protective film and positioning sticker in FIG. 4;

FIG. 6 is a schematic diagram of the side view structure in FIG. 3;

FIG. 7 main view structure diagram of another flexible screen protective film provided by the embodiment of the utility model;

FIG. 8 is the side view structure diagram in FIG. 7.

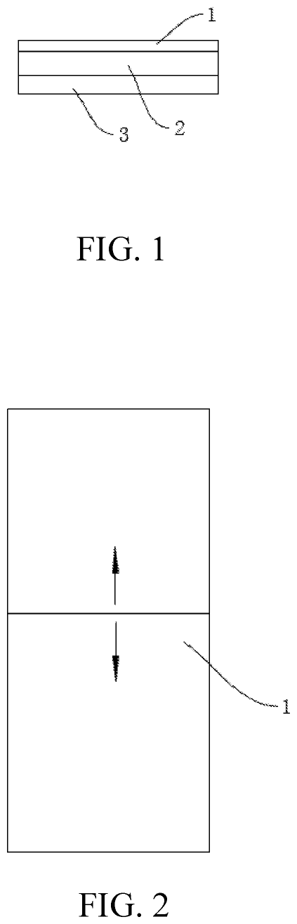

In the figure: 1. Release film; 2. Flexible application layer; 21. First gluing area; 22. Second gluing area; 3. Surface protective film; 4. Positioning sticker; 41. Connecting interval; 5. First convex lug; 6. Second convex lug.

### CONCRETE MANIFESTATION

In order to make the technical problems, technical solutions and beneficial effects to be solved by the utility model more clearly, the utility model will be further described in detail below in combination with the attached figures and embodiments. It should be understood that the specific embodiments described herein are only used to explain the utility model and are not used to define the utility model.

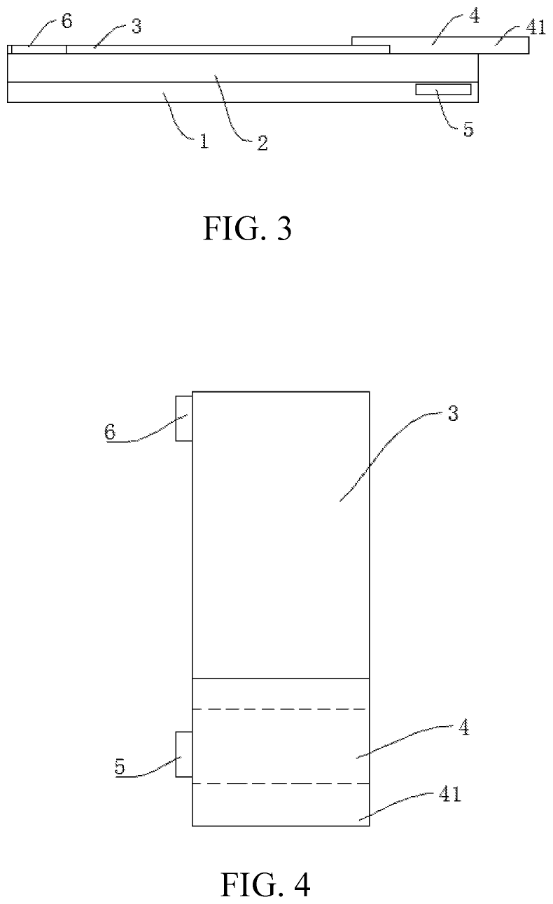

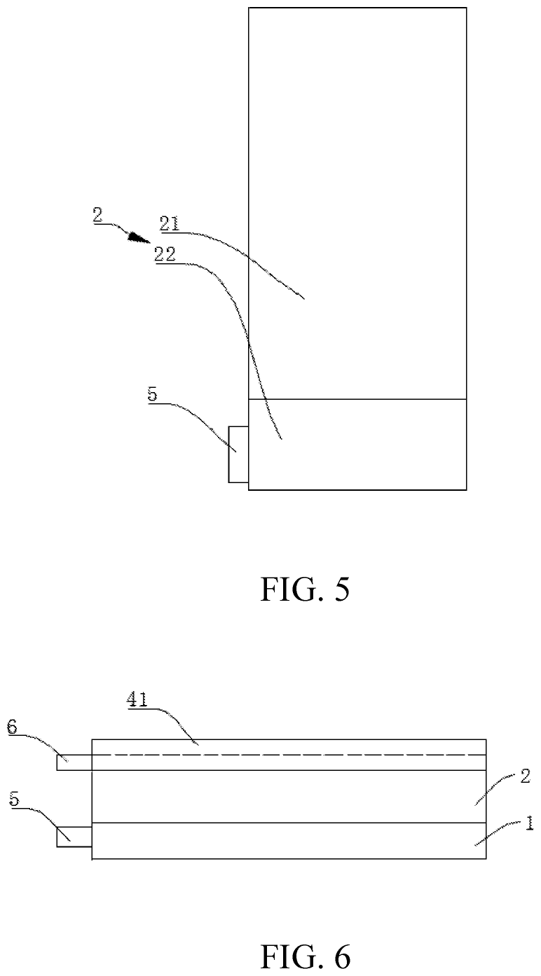

Please refer to FIG. 3-8 together, and now a flexible screen protective film provided by the utility model is described. The flexible screen protective film comprises a flexible application layer 2, a release film 1, a surface protective film 3 and a positioning sticker 4. The upper end face of the flexible application layer 2 is divided into a first gluing area 21 and a second gluing area 22 which forms the upper end face together with the first gluing area 21; the release film 1 is glued to the lower end surface of the flexible application layer 2; the surface protective film 3 is glued to the first gluing area 21 on the upper end face of the flexible application layer 2; the positioning sticker 4 is glued with the second gluing area 22 of the upper end face of the flexible application layer 2, one end of the positioning sticker 4 is connected with the surface protective film 3, and the other end protrudes from the outer edge of the flexible application layer 2 as the free end.

When the flexible screen protective film is used, the positioning sticker 4 is fixed on the device to position the flexible screen protective film, and then the release film 1 is separated from the end close to the positioning sticker 4, while the release film 1 is separated, the flexible application layer 2 is adhered with the screen to be pasted, until the release film 1 and the flexible application layer 2 are completely separated. At this time, the flexible application layer 2 completely fits the screen to be pasted. Then use the scraper to repeatedly press the surface protective film 3, so that the flexible application layer 2 and the screen surface closely fit to avoid bubbles between the flexible application layer 2 and the screen, and then respectively tear off the positioning sticker 4 and the surface protective film 3.

Compared with the prior art, the utility model provides a flexible screen protective film, which can separate the release film 1 and the flexible application layer 2 with the help of a positioning sticker 4. When the flexible screen protective film is adhered, the release film 1 does not need to be cut, and the release film 1 does not need to be separated from the middle of the release film 1 to both sides in the order of separation. The film applicator can tear the release film 1 from any direction, which facilitates the separation of the release film 1 and the flexible application layer 2. There is no cut mark on the release film 1, and the flexible protective film will not produce traces or blisters when it is attached to the screen, which improves the adhering effect of the flexible film and the screen. The surface protective film 3 avoids the deformation of the flexible application layer 2 in the process of repeatedly pressing the surface protective film 3 by the scraper. The positioning sticker 4 has the positioning function, which facilitates the fitting of the flexible screen protective film and the screen.

It should be noted that the flexible application layer 2 is made of flexible material, with certain ductility, generally TPU or PVC material.

The surface protective film 3 and release film 1 are generally made of non-malleable materials such as PET or OPP.

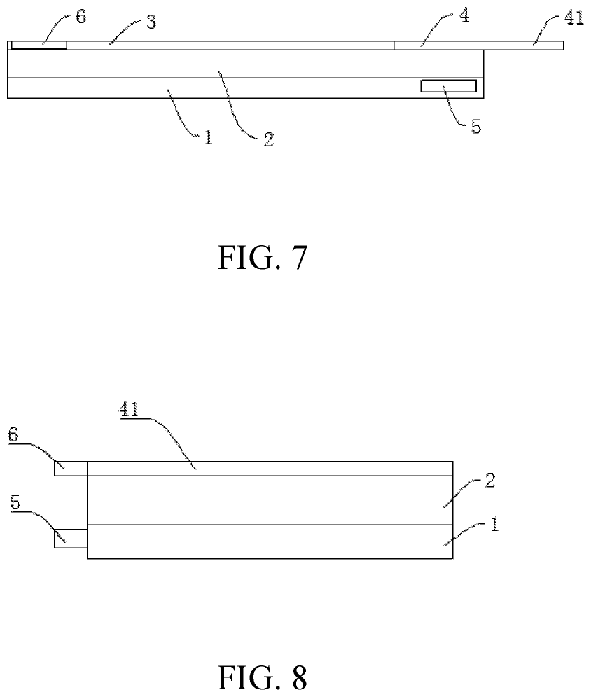

As a concrete manifestation of the embodiment of the utility model, please refer to FIG. 7 and FIG. 8 together, that one end of the positioning sticker 4 is connected with one end of the surface protective film 3. This saves the material needed for the flexible screen protective film and reduces the production cost.

In this embodiment, the positioning sticker 4 can be integrated with the surface protective film 3, or can be separated from the surface protective film 3. When the positioning sticker 4 is separated from the surface protective film 3, the connection can be realized with the aid of glue.

As a concrete manifestation of the embodiment of the utility model, please refer to FIG. 3-6 together, that the lower end face of one end of the positioning sticker 4 is connected with the upper end face of the surface protective film 3. In the production of the flexible screen protective film, the surface protective film 3 is first adhered to the first gluing area 21 of the upper end face of the flexible application layer 2, and then the positioning sticker 4 is adhered to the second gluing area 22 of the upper end face of the flexible application layer 2, the positioning sticker 4 can overlap with the surface protective film 3, the connection between the positioning sticker 4 and the surface protective film 3 is simple, the production process is simple, and the production efficiency of the flexible screen protective film can be effectively improved.

As a concrete manifestation of the embodiment of the utility model, please refer to FIG. 3-8 together, that the free end of the positioning sticker 4 is provided with a connection interval 41 for detachable connection with the positioner or the equipment surface. The connection interval 41 improves the positioning accuracy of the positioning sticker 4. The connection interval 41 can be connected with the device in various ways according to the type of device (such as mobile phone, tablet PC, etc.) to which the film is required.

In this embodiment, the connecting interval 41 comprises a double-sided adhesive structure. During use, remove the protective film on the surface of the connecting interval 41, and then fit the rubber surface of the connecting interval 41 with the surface of the equipment.

In this embodiment, the connection interval 41 also includes a plastic film structure. The connection interval 41 is fixedly connected with the positioner, and then the film application operation is started.

As a concrete manifestation of the embodiment of the utility model, the adhesive force between the release film 1 and the flexible application layer 2 is less than that between the positioning sticker 4 and the flexible application layer 2. This ensures that when the release film 1 is separated from the flexible application layer 2, the positioning sticker 4 and the surface protective film 3 can still adhere with the flexible application layer 2 stably.

As a concrete manifestation of the embodiment of the utility model, please refer to FIG. 3-8 together, that the first gluing area 21 and the second gluing area 22 are successively arranged along the length direction of the flexible application layer 2. The first gluing area 21 and the second gluing area 22 are arranged along the length direction of the flexible application layer 2, and the length of the required surface protective film 3 and the positioning sticker 4 is long, which can facilitate and quickly cut the surface protective film 3 and the positioning sticker 4 in the production process. The length of the first gluing area 21 is greater than the length of the second gluing area 22, the firmness of the connection between the positioning sticker 4 and the flexible application layer 2 is greater than that between the surface protection film 3 and the flexible application layer 2, the second gluing area 22 corresponding to the gluing positioning sticker 4 is smaller, which facilitates the separation of the surface protective film 3, the positioning sticker 4 and the flexible application layer 2.

As a concrete manifestation of the embodiment of the utility model, please refer to FIG. 3-8 together, that the release film 1 is fixedly connected with a first convex lug 5 protruding from the outer edge of the flexible application layer 2. The first convex lug 5 facilitates the separation of the release film 1 and the flexible application layer 2.

As a concrete manifestation of the embodiment of the utility model, please refer to FIG. 3-8 together, that the protective film3 is fixedly connected with a second convex lug 6 protruding from the outer edge of the flexible application layer 2. The second convex lug 6 facilitates the separation of the surface protective film 3 from the flexible application layer 2.

The above is only a preferred embodiment of the utility model, and is not used to limit the utility model. Any modification, equivalent replacement and improvement made within the spirit and principle of the utility model shall be included in the protection scope of the utility model.

1. A flexible screen protective film is characterized in that it comprises:
The upper end face of the flexible application layer (2) is divided into a first gluing area (21) and a second gluing area (22) which forms the upper end face together with the first gluing area (21);
The release film (1) is glued to the lower end surface of the flexible application layer (2);
The surface protective film (3) is glued to the first gluing area (21) on the upper end face of the flexible application layer (2); and
The positioning sticker (4) is glued with the second gluing area (22) of the upper end face of the flexible application layer (2), one end of the positioning sticker (4) is connected with the surface protective film (3), and the other end protrudes from the outer edge of the flexible application layer (2) as the free end.

2. The flexible screen protective film according to patent claims 1, which is characterized in: one end of the positioning sticker (4) is connected with the surface protective film (3).

3. The flexible screen protective film according to patent claims 1, which is characterized in: the lower end face of one end of the positioning sticker (4) is connected with the upper end face of the surface protective film (3).

4. The flexible screen protective film according to patent claims 1, which is characterized in: the free end of the positioning sticker (4) is provided with a connection interval (41) for detachable connection with the positioner or the equipment surface, the connecting interval (41) comprises a double-sided adhesive structure.

5. The flexible screen protective film according to patent claims 1, which is characterized in: the adhesive force between the release film (1) and the flexible application layer (2) is less than that between the positioning sticker (4) and the flexible application layer (2).

6. The flexible screen protective film according to patent claims 1, which is characterized in: the first gluing area (21) and the second gluing area (22) are successively arranged along the length direction of the flexible application layer (2), and the length of the first gluing area (21) is larger than the length of the second gluing area (22).

7. The flexible screen protective film according to patent claims 1, which is characterized in: the release film (1) is fixedly connected with a first convex lug (5) protruding from the outer edge of the flexible application layer (2).

8. The flexible screen protective film according to patent claims 1, which is characterized in: the protective film (3) is fixedly connected with a second convex lug (6) protruding from the outer edge of the flexible application layer (2).
